(19) United States
(12) Patent Application Publication
(10) Pub. No.: US 2010/0002432 A1
(43) Pub. Date: Jan. 7, 2010

(54) INDIRECT LUMINAIRE UTILIZING LED LIGHT SOURCES

(75) Inventor: Perry Romano, Bradenton, FL (US)

Correspondence Address: Levenfeld Pearlstein, LLC;Intellectual Property Department, 2 North LaSalle, Suite 1300, Chicago, IL, 60602, US

(73) Assignee: HUBBELL INCORPORATED, Orange, CT (US)

(21) Appl. No.: 12/389,887

(22) Filed: Feb. 20, 2009

Related U.S. Application Data
(60) Provisional application No. 61/078,537, filed on Jul. 7, 2008.

(51) Int. Cl. F21S 8/00; F21V 29/00; F21V 7/04

(52) U.S. Cl. 362/235; 362/294; 362/296.01

(57) ABSTRACT

A luminare uses an indirect reflector system to harness the concentrated light from an array of LED luminaires and direct the lumens where needed. The luminare allows for optical control and little to no glare by re-focusing the concentrated light emitted from each LED luminaire on the reflector at desired angles required for the selected lighting. A satin finish on the reflector diffuses the LED lamp image brightness and increases uniformity of illumination on the ground.

### CROSS-REFERENCE TO RELATED APPLICATION

This application claims the benefit of priority of Provisional U.S. Patent Application Ser. No. 61/078,537, filed Jul. 7, 2008, entitled “LED LIGHT ENGINE AND HEAT SINK”.

### BACKGROUND OF THE INVENTION

The present invention is directed to lighting. More particularly, the present invention pertains to LED lighting for architectural and outdoor lighting.

LED (light emitting diode) technology has been widely used in many consumer products for nearly four decades. The most common use for LED has been in indicator lights. The high brightness and point-source characteristics of LEDs have allowed them to be widely accepted in use for traffic signals and in the automotive industry, for example, in tail lights.

Although the brightness of LEDs have made them a good alternative to incandescent lamps in signaling devices, they have previously lacked the lumen output and optical control required for general illumination. In addition, their high initial cost was also a significant barrier to market entry.

Early efforts to utilize LEDs for general illumination raised the awareness of LED technology, but the narrow beam distribution and unfounded claims of 100,000+ hour life delayed the understanding and full acceptance of LEDs being used for outdoor area lighting.

Until recently, the light output of LED sources made the technology an inefficient choice for outdoor area lighting. However, recent increases in LED efficacy coupled with an LED reflector system have made LEDs a good choice for lighting public spaces such as general outdoor illumination in street lighting, pathway lighting, parking lot lighting, marina lighting, residential outdoor lighting, planned communities, mixed use recreational trails, and village town centers

In raw form, LED lenses control the distribution of light. But because most LED lenses have been designed to distribute light in narrow beams, most manufacturers attempting to use LED sources for area lighting physically rotate large linear arrays of LEDs to achieve light at higher angles. By rotating the LED arrays, the unshielded brightness results in high levels of glare. Glare has been known to limit the viewer's ability to see the lighted road or pathway, which can lead to an unsafe condition.

Accordingly, there is a need for a universal system to harness the concentrated light from the LEDs and apply the lumens exactly where needed while managing glare. Desirably, such a system would allow for superior optical control, appropriate outdoor lighting positioning or spacing and little to no glare.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a top perspective view of a luminare embodying the principles of the present invention;

FIG. 2 is a bottom perspective view of the luminaire of FIG. 1;

FIG. 3 is a perspective view of the reflector and the LED array (also known as the light engine);

FIG. 4 is a perspective view of an embodiment of the reflector;

FIG. 5 is a perspective view of another embodiment of the reflector;

FIG. 6 is a light reflection diagram using the reflector of FIG. 4;

FIG. 7 is a light reflection diagram using the reflector of FIG. 5;

FIG. 8 is a light dispersion grid using the reflector of FIG. 4;

FIG. 9 is a light dispersion grid using the reflector of FIG. 5;

FIG. 10 is a perspective view of an embodiment of the light engine housing;

FIG. 11 is a top view of the light engine housing of FIG. 10;

FIG. 12 is a side view of the light engine housing of FIG. 10;

FIG. 13 is a bottom view of the light engine housing of FIG. 10;

FIG. 14 is a cross-sectional view of the light engine housing of FIG. 13 taken along line 14-14;

FIG. 15 is a bottom view of the cylinder of the housing of the present invention;

FIG. 16 is a perspective view of the LED array;

FIG. 17 is a perspective view of another embodiment of the light engine housing;

FIG. 18 is a top view of the housing of FIG. 17;

FIG. 19 is a side view of the housing of FIG. 17;

FIG. 20 is a bottom view of the housing of FIG. 17;

FIG. 21 is a cross-sectional view of the housing of FIG. 20 taken along line 21;

FIG. 22 is a cross-sectional view of FIG. 20 taken along line 22-22.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention”, relates to a requirement of the United States Patent Office, and does not imply, nor should be inferred to limit the subject matter disclosed herein.

Rather than using multiple large, angled linear LED arrays to produce the light required for area lighting, the present luminare uses an indirect reflector system to harness the concentrated light from the array of individual LEDs and apply the lumens where needed. The present invention allows for optical control and little to no glare by re-focusing the concentrated light emitted from each LED on the reflector at the desired angles required for area lighting. A satin finish on the reflector may be used to diffuse the brightness and increases uniformity of illumination on the ground. In an effort to manage glare, secondary reflector materials may be used to control and diffuse the concentrated light levels emitted from LED sources. A single power source for the array maximizes the LED luminaire array efficiency. Alternatively, multiple power sources may be used.

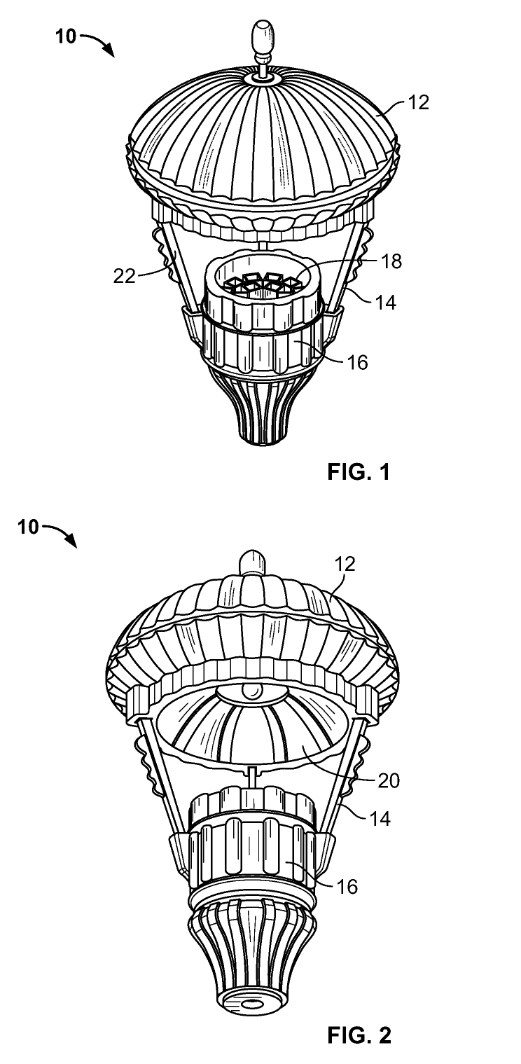

Referring now to the figures and in particular FIGS. 1 and 2, there is shown an embodiment of the luminare 10 having a top 12, a cage 14, and a housing 16. Positioned in the housing 16 is an LED array 18 composed of multiple LEDs. A reflector 20 is positioned on an underside of the top 12, the reflector 20 is a concave, reflective surface positioned over the LED array 18. The LED array 18 and reflector 20 may be surrounded by a transparent or semi-transparent, or opaque lens chamber 22. The cage 14 and housing 16 are constructed of rugged cast aluminum to ensure durability under wind loading. The luminare 10 can be sealed in a transparent or semi-transparent glass or polymer chamber 22. Light is projected into a high efficiency reflector system 20 that provides the optimum distribution of light on the ground area that it is intended to light.

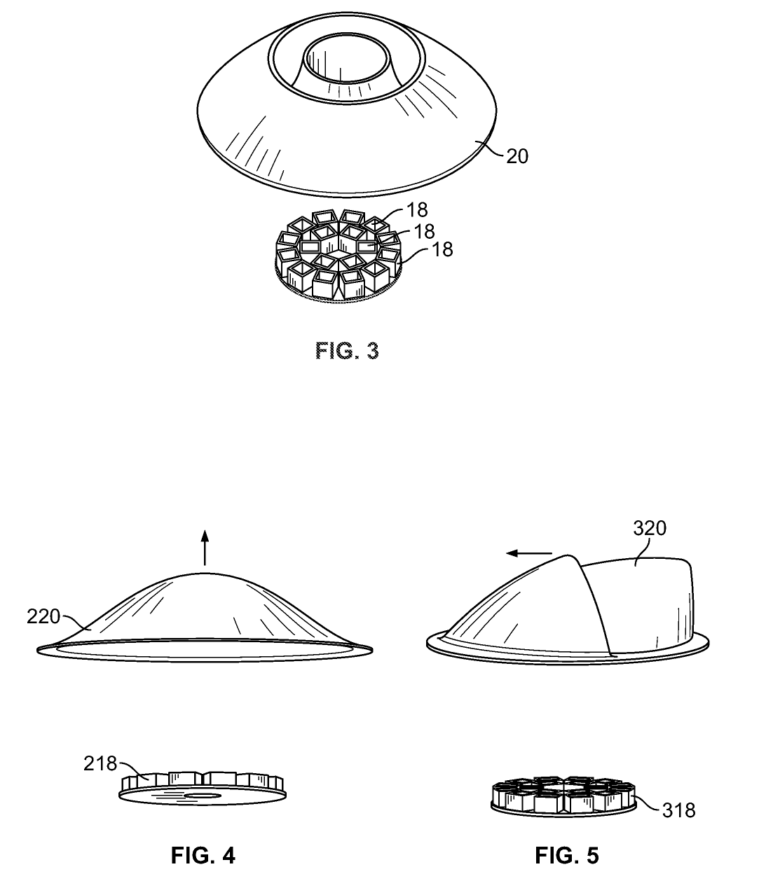

FIG. 3 shows the reflector 20 and the LED array 18 without the top 12, cage 14, or housing 16. The LED array 18, in the present embodiment, is composed of eighteen (18) individual LEDs. The LED array 18 produces a luminous efficacy (the amount of visible light produced, in lumens, per the power consumed) of up to 100 lumens or more per watt. In comparison, for example, a 100W (120V) tungsten incandescent bulb has approximately 16.8 lumens per watt, and natural sunlight has 93 lumens per watt, with the remainder of the electromagnetic energy dissipated as heat or wavelengths outside the visible spectrum.

The reflector 20 is a concave reflective surface that refocuses the concentrated light received from the luminaire array 18 to provide an indirect lighting source. The reflector 20 may have a satin finish to diffuse the lamp image brightness and increase uniformity of lighting on the ground.

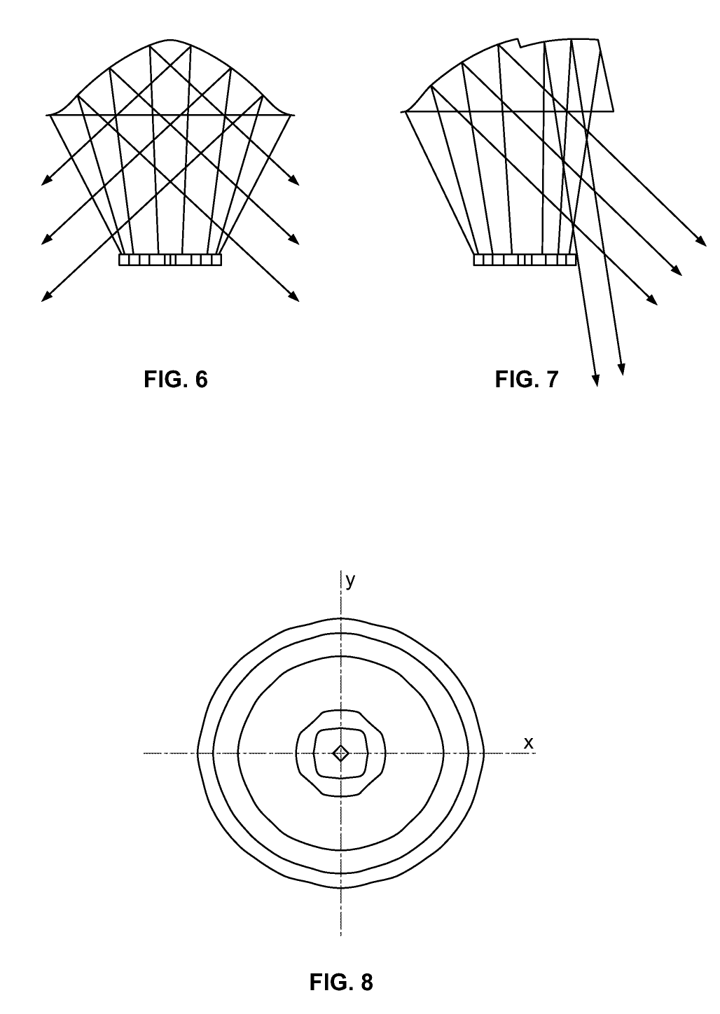

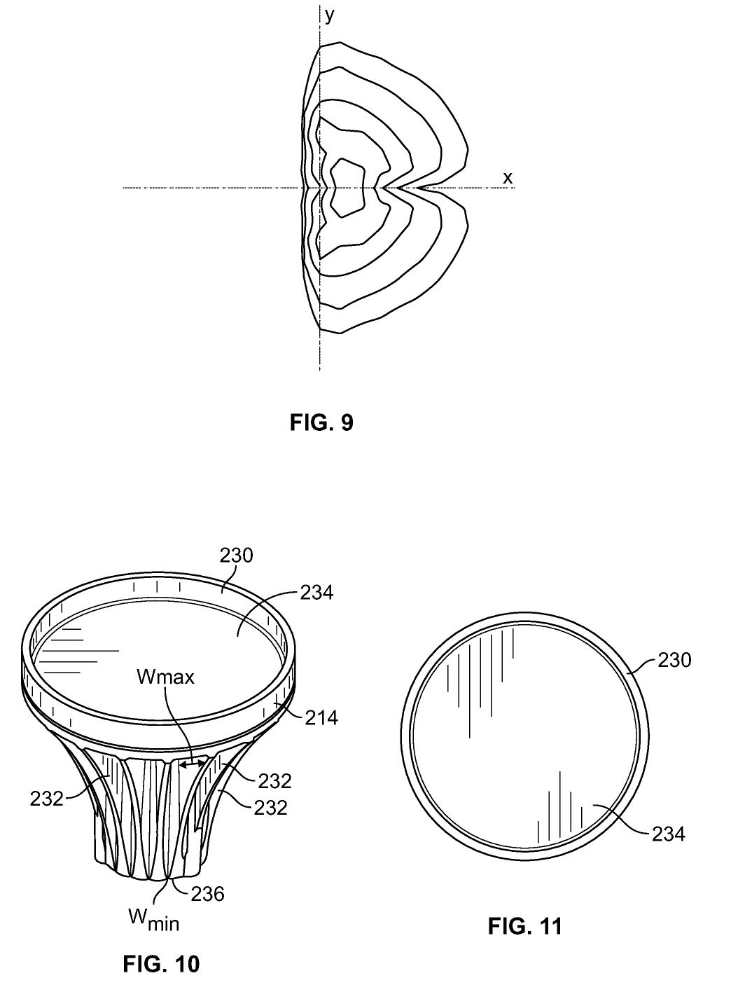

FIGS. 4 and 5 show two embodiments of the present reflector. It is understood that the two embodiments shown do not limit the varieties of reflector shapes possible, but are only examples of possible embodiments for further understanding of the present invention. FIG. 4 shows a reflector 220 made from stamped aluminum or other reflective material. The reflector 220 has a symmetrical, concave shape with an LED array 218 disposed below the reflector 220. FIG. 6 illustrates the LED array 218 illuminating the reflector 220 (of FIG. 4) and the light being reflected off the reflector's concave surface. The reflector 220 is formed such that it reflects the light from the LED array 218 as shown in the light dispersal grid of FIG. 8. The light dispersal grid of FIG. 8 shows the intensity and pattern of light disbursement radially from the reflector 220. The LED array 218 includes eighteen individual LEDs, each LED operated at 1W. The reflector 220 reflects the light from the LED array 218 in a manner so that the area radial from the LED array 218 in FIG. 8 is illuminated up to a large distance radially from the center of the LED array 218 when the present luminare is mounted at a height often (10) feet.

In order to prevent light trespass or to have more focused, directed light, the reflector of the present invention can be designed to reflect the light in certain areas. For example, FIG. 5 shows an embodiment of a reflector 320 disposed above an LED array 318. The reflector 320 in this embodiment is asymmetrical about the center of the LED array 318, and symmetrical along a longitudinal axis. The reflector 320 is configured to reflect and disperse the light from the LED array 318 as shown in FIGS. 7 and 9. The light dispersal grid of FIG. 9 shows the intensity and pattern of light disbursement radially from light source, LED array 318. The LED array 318 includes eighteen individual LEDs, each LED operated at 1W. The light from the LED array 318 is reflected and dispersed by the reflector 320 in an asymmetrical manner radially from the center of the LED array 318, and symmetrically about a longitudinal or x-axis as shown in the light dispersal grid of FIG. 9. In this way, the light may be focused as desired in certain areas.

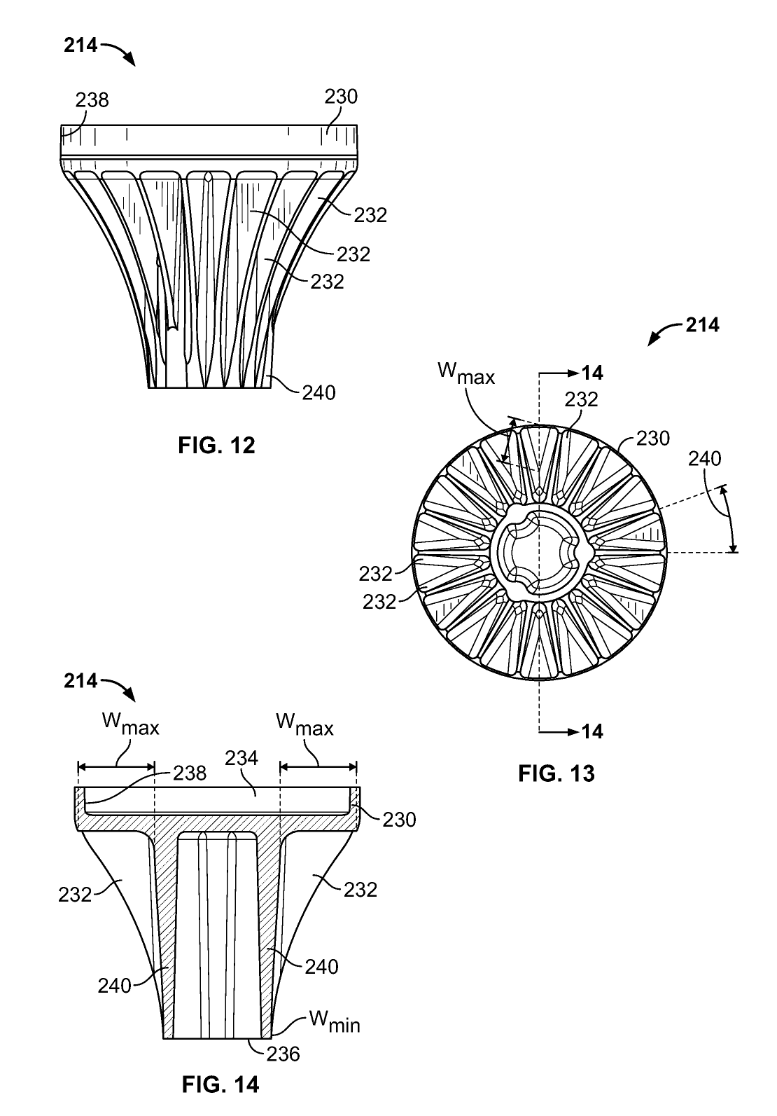

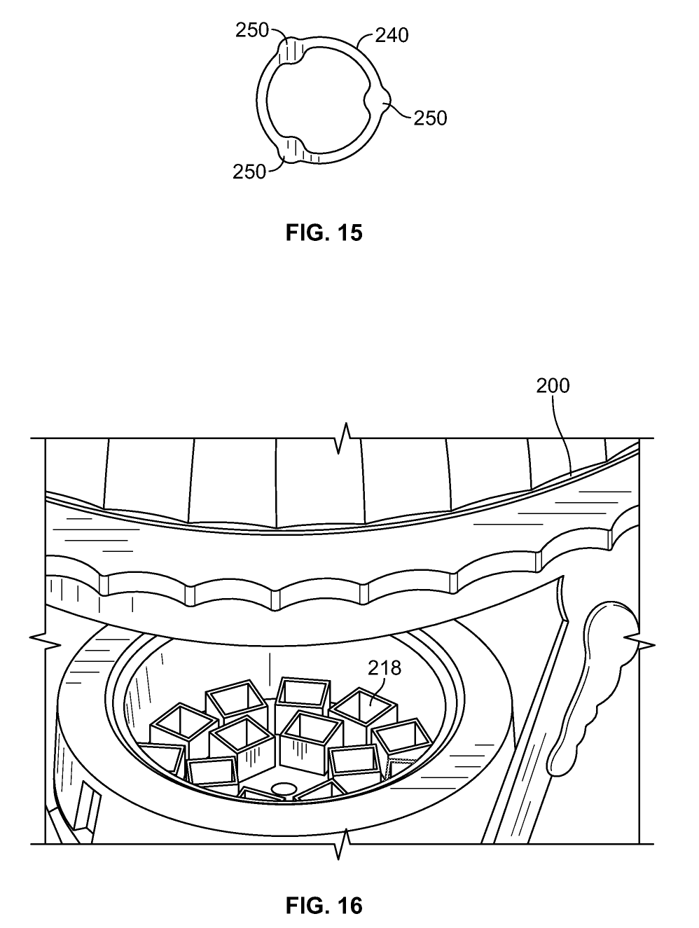

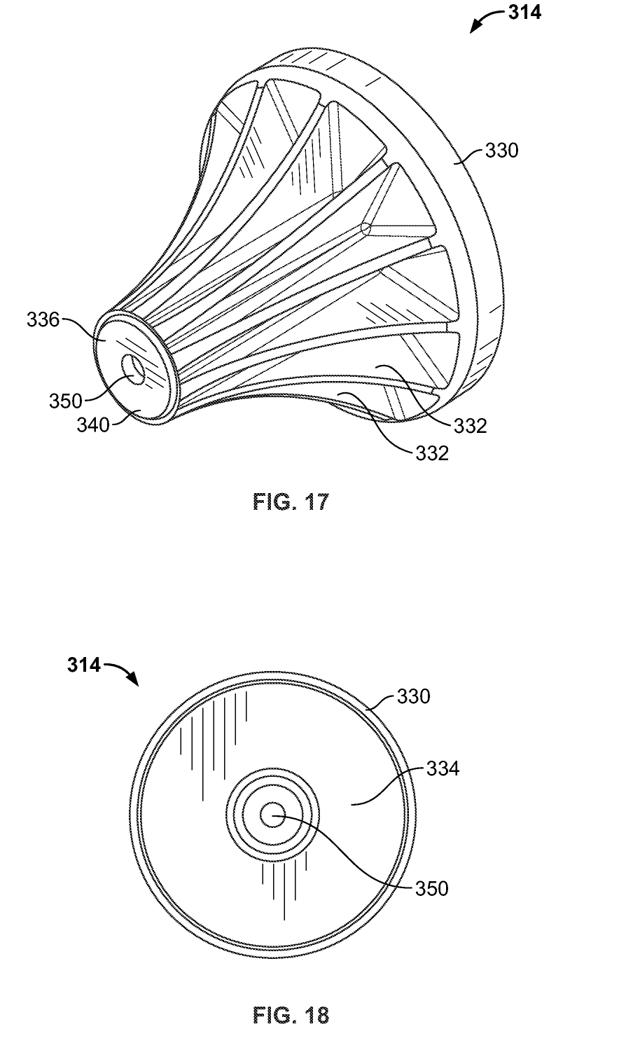

Turning now to FIGS. 10-15, FIGS. 10-15 show various views of an embodiment of the housing of the present invention. In FIG. 10, the housing 214 is a cylinder or barrel-shape body 240 with a wide mouth or upper rim 230 and is made from a high thermal conductivity material, for example, a metal such as cast aluminum. Three boss holes 250 are positioned 120 degrees apart around the cylinder 240 for mounting to the luminaire. The housing 214 incorporates heat dissipation elements or heat sinks in the form of eighteen (18) cooling fins 232, spaced twenty (20) degrees apart and integral with the cylinder body 240 to dissipate the heat of the LED array (shown in FIG. 16).

While it is widely understood that LEDs do not generate nearly the amount of heat as for example, incandescent lights, they nonetheless do generate some amount of heat. Unlike other sources which dissipate a significant amount of heat as infrared radiation, LED emissions are mainly limited to the visible spectrum. Due to the small size of LEDs direct convective heat transfer is limited as well. And, due to the electronic nature of the LEDs, the operating temperature must be kept relatively low in order for the LEDs to operate within a desired efficacy range and at conditions favorable to long life. Due to these factors “high power” LED luminaires must have in place components to dissipate heat from the LEDs through conduction. As such the housing 214 serves as a heat sink to maintain the LEDs at such favorable conditions. A plurality of heat dissipating elements, such as cooling fins 232, are disposed circumferentially around the housing 214. Each fin 232 runs longitudinally from a maximum width Wmax at the outer portion of mouth 230 and tapers to a minimum width Wmin at the base 236 of the housing 214. Too much heat in the housing 214 can affect the overall performance and life of the LED lighting engine, can affect the light's intensity, and can decrease the life of the luminaire. Thus, the cooling fins 232 act to dissipate the heat from the present invention and increase life of the luminaire.

A flat horizontal surface 234 is disposed within the interior of the mouth 230 and supports the LED array. The flat, horizontal surface may be machined to achieve a flatness of plus or minus 0.005 inches. The inner surface perimeter 238 of the mouth 230 is perpendicular or approximately perpendicular to the horizontal surface 234. The individual LEDs 218 are arranged in concentric circles and mounted to a circuit board to form the LED array, which is in turn mounted on the flat surface 234 of the housing 214, as shown in FIG. 16. A thermally conductive medium such as “thermal grease” or a “thermal pad” may be interposed between the circuit board and the housing 214 to reduce the thermal impedance across the gap and enhance heat transfer from the LEDs. Also note that the LEDs may individually be covered by lenses. In the preferred embodiment the lenses will render a narrow (or spot) distribution. This will have the effect of directing most of the light directly into the reflector with a minimal amount of light spilled out as uplight (increasing luminaire efficiency and reducing light pollution), and all light beams will tend to converge as one pattern which makes optical design easier and the overall distribution more controllable.

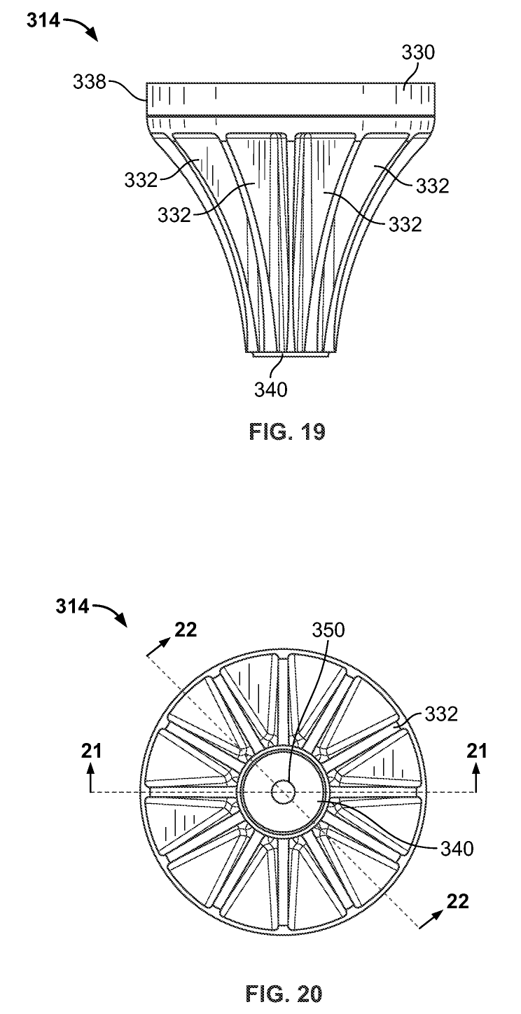

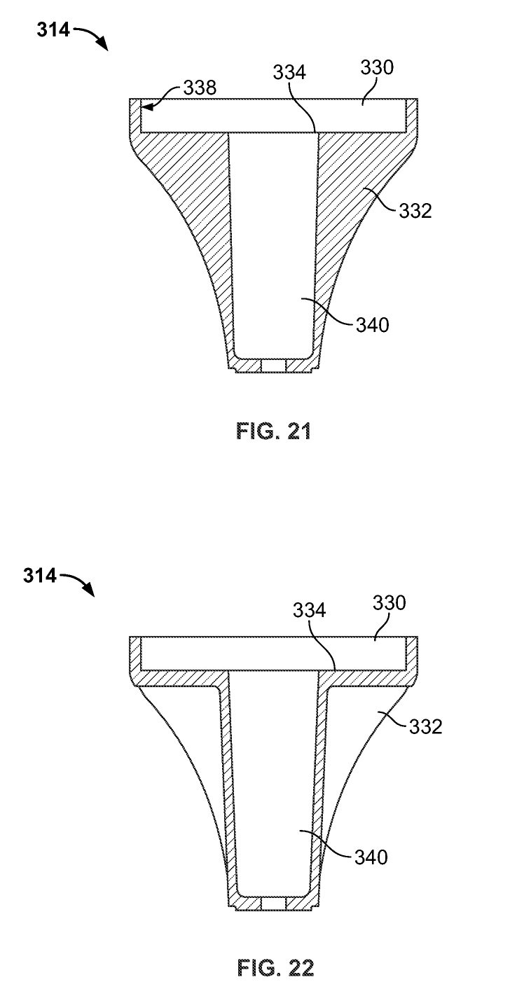

FIGS. 17-22 show another embodiment of the housing of the present invention. In FIG. 17, the housing 314 is a cylinder or barrel-shape body 340 with a wide mouth or upper rim 330 and a central boss hole 350 for wiring. The housing 314 is made from cast aluminum, weighing less than three pounds, approximately 2.7 pounds. The housing 314 incorporates a dissipation element or heat sink in the form of cooling fins 332 integral with the cylinder body 340 to dissipate the heat of the LED array. The housing 314 has a plurality of cooling fins 332, in this instance twelve (12) cooling fins which are disposed circumferentially, 30 degrees apart, along the housing 314. Each fin 332 runs longitudinally from a maximum width Wmax at the outer portion of mouth 330 and tapers to a minimum width Wmin at the base 336 of the housing 314. Too much heat in the housing 314 greatly affects the overall performance and life of the LED lighting engine, affects the light's intensity, and greatly decreases the life of the luminaire. Thus, the cooling fins 332 act to dissipate the heat from the present invention and increase life of the LED lighting engine.

A flat horizontal surface 334 is disposed within the interior of the mouth 330 and supports the LED array. The flat, horizontal surface may be machined to achieve a flatness of plus or minus 0.005 inches. The inner surface perimeter 338 of the mouth 330 is perpendicular or approximately perpendicular to the horizontal surface 334. The individual LEDs 318 are arranged in single layer, concentric circles on the circuit board which is in turn mounted on the flat surface 334 of the housing 314.

A chamber 22 protects the electrical components of the present invention from environmental contaminants such as dust and water. The chamber 22 gives a dirt-free, insect-free environment between normal servicing operations. In lieu of this chamber, a glass or polymer lens/diffuser may be horizontally disposed directly above the LEDs, leaving the space between the lens and the reflector open. The lens may also be used to diffuse the light or adjust the color. The LED driver is sealed in a weather-tight housing and may accommodate supply voltages 100-277V 50/60 Hz.

The modular design of the present invention accommodates varied lighting output from LEDs available in various colors, and in white color with various correlated color temperatures. The color temperature of a light source is the temperature at which an ideal (blackbody) radiator will emit a color (wavelength distribution) comparable to the light source in question. Practically it is an indication of whether the light will have more of a reddish (warm) or a blue-white (cool) hue. Color temperature is measured on the Kelvin scale where the “cooler” the light, the higher the temperature. Warm lights are generally understood to be those below 3,100 K and cool lights are generally understood to be those over 4,000 K; 3,500 K is considered neutral light.

Another significant advantage of the present luminare that will be readily apparent is its universal application. That is, with a minimum number, perhaps only one, of standard configurations of light engines and heat sinks, a wide variety of lighting applications can be addressed. Rather than individually designed LED housings and carriages, in which the LEDs are precisely positioned at various angles to achieve a desired lighting pattern, the present universal housing design, in conjunction with specifically configured or desired reflectors, is used to achieve almost any desired lighting pattern. It will be appreciated that it is significantly easier to vary the design of and to fabricate reflectors (which are generally stamped, spun, hydroformed, etc. fabrications) than it is to vary the design of LED boards and mounting components. As such, the use of an essentially “universal” housing with different reflector designs provides a wider variety of lighting choices, effects, and patterns, all at lower costs.

The present invention also has a minimum CRI (color rendering index) of eighty-two (82). The CRI is measured on a scale of 1 to 100, where 100 represents how colors look in daylight. The higher the number, the more accurately the artificial light will render colors. Thus, a CRI of 82 indicates that the present invention illuminates colors in a manner similar to natural light.

The LED array 18, (wherein several LEDs may be connected in series, and several series or “strings” may in turn be connected in parallel) is driven by one or more constant current LED source(s). Because LEDs are current-driven devices whose brightness is proportional to its forward current input, the present invention LED array is driven with a constant current source to reduce the fluctuations in brightness that may be experienced with constant voltage sources. The constant current LED driver(s) have a power factor of greater than ninety-two percent (>92%) and THD (total harmonic distortion) less than twenty percent (<20%). The power sources may be 120-277VAC, and drive the LED array to 24W or 48W or more. At present the LED driver(s) has a rated life of 100,000 hours MTBF.

Other advantages to the present invention include 50,000 hour life, up to five times the life of HID (high intensity discharge) sources, low energy consumption, better color rendition and nighttime visibility, no warm-up or cold start problems that HID and CFL and other lighting methods experience, significant operational savings by using less energy, environmental impact in that it eliminate hazardous disposal.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A luminare for outdoor lighting comprising:
a top;
a cage;
a housing, wherein the top, cage, and housing are connected, the housing configured to carry an array of LEDs in a standard configuration, the housing fabricated from a high thermal conductivity material and having a flat surface for receiving the array of LEDs;
a reflective surface mountable in the top; and
at least one heat-dissipating element, the heat dissipating element integral with the housing and configured to dissipate heat from the LED array. The heat dissipating element need not necessarily be a fin, but could be any surface area or other feature which acts to dissipate heat.

2. The luminare in accordance with claim 1, wherein the reflective surface is configured to reflect light from the LED array into a desired pattern.

3. The luminare in accordance with claim 1, wherein the reflective surface redistributes light received from the LED array to provide indirect lighting.

4. The luminare in accordance with claim 1 wherein the reflective surface has a satin finish.

5. The luminare in accordance with claim 1 wherein the reflective surface has a symmetrical pattern.

6. The luminare in accordance with claim 1 wherein the reflective surface has an asymmetrical pattern.

7. The luminare in accordance with claim 1 including multiple interchangeable reflective surfaces providing differing light distributions.

8. The luminare in accordance with claim 1 wherein the housing is aluminum.

9. The luminare in accordance with claim 1 wherein the housing includes a flat platform configured for supporting the array of LEDs.

10. The luminare in accordance with claim 1 wherein the at least one heat dissipating element is a fin.

11. The luminare in accordance with claim 1 wherein the cage is a transparent, an opaque, or a semitransparent chamber.

12. The luminare in accordance with claim 1 wherein the cage is a metal or polymer frame.

13. The luminare in accordance with claim 1 further comprising a plurality of fixtures into which the is the array of LEDs are installed.

14. A luminare for outdoor lighting comprising:
a top;
a housing, wherein the top and housing are removably connected, the housing configured to carry an array of LEDs in a standard configuration, the housing fabricated from aluminum and having an open, central, flat platform for supporting the array of LEDs;
a reflective surface mountable in the top, wherein the reflective surface has a satin finish and is configured to reflect and redistribute light from the LED array in a desired pattern to provide indirect lighting; and
at least one heat-dissipating element, the heat dissipating element integral with the housing and configured to dissipate heat from the LED array.

15. A luminare for outdoor lighting comprising:
a top;
a cage, wherein the cage is a transparent chamber, an opaque chamber, or a semitransparent chamber, or a metal or polymer frame;
a housing, wherein the top, cage, and housing are connected, the housing configured to carry an array of LEDs in a standard configuration, the housing fabricated from aluminum and having an open, central, flat platform for supporting the array of LEDs;
a reflective surface mountable in the top, wherein the reflective surface has a satin finish and is configured to reflect and redistribute light from the LED array in a desired pattern to provide indirect lighting; and
at least one heat-dissipating element, the heat dissipating element integral with the housing and configured to dissipate heat from the LED array.
